(19) United States
(12) Patent Application Publication
(10) Pub. No.: US 2014/0005873 A1
(43) Pub. Date: Jan. 2, 2014

(54) AUTONOMOUS MOBILE DEVICE, METHOD OF RESTRAINING MOVEMENT RANGE THEREOF, AND AUTONOMOUS MOBILE DEVICE SYSTEM

(71) Applicant: AGAIT TECHNOLOGY CORPORATION, New Taipei City (TW)

(72) Inventors: Tien-Chen CHEN, New Taipei City (TW); Yang-Tzung LIEN, New Taipei City (TW); Tian-Rong XIE, New Taipei City (CN)

(73) Assignee: AGAIT TECHNOLOGY CORPORATION, New Taipei City (TW)

(21) Appl. No.: 13/833,795

(22) Filed: Mar. 15, 2013

(30) Foreign Application Priority Data
Jul. 2, 2012 (TW) 101212755

(51) Int. Cl. G05D 1/02

(52) U.S. Cl. CPC G05D 1/0261; Y10S 901/01
USPC 701/23; 901/1

(57) ABSTRACT

An autonomous mobile device system includes a plurality of magnetic components and an autonomous mobile device. The magnetic components are adapted to be arranged on a surface in a space-apart manner and produce a magnetic field serving as a virtual boundary on the surface. The autonomous mobile device is configured to move on the surface, and includes a housing, a magnetic sensor for detecting the magnetic field, and a motion control module for controlling movement of the autonomous mobile device. The motion control module is operable in a first movement mode, in which the autonomous mobile device is restrained from crossing the virtual boundary when the magnetic sensor detects the magnetic field.

### CROSS-REFERENCE TO RELATED APPLICATION

This application claims priority of Taiwanese Application No. 101212755, filed on Jul. 2, 2012.

### BACKGROUND OF THE INVENTION

1. Field of the Invention

The invention relates to an autonomous mobile device, more particularly to an autonomous mobile device whose movement range may be properly restrained.

2. Description of the Related Art

Generally, an autonomous mobile device (such as an automatic lawnmower, an automatic floor scrubber, etc.) is typically assigned to perform a predetermined task (i.e., mowing the lawn, scrubbing the floor, etc.) within a specific area. After the task within the specific area is completed, the autonomous mobile device can be instructed to move to another area for performing the task. It is important that a closed boundary defining the specific area be well-arranged in order to ensure that the autonomous mobile device does not inadvertently move out of the specific area and does not move aimlessly as a result.

U.S. Pat. No . 7,613,543 B2 discloses a conventional autonomous mobile device system that includes such an autonomous mobile device. In the system, at least one electrical cable is connected to a signal generator for transmitting a magnetic field which can propagate through the air. The electrical cable is disposed on a surface (e.g., a floor) for defining an area. The autonomous mobile device is configured to search for the area, and to perform the task within the area.

However, the conventional autonomous mobile device system described above has some drawbacks. For example, an electrical wiring procedure must be first performed on the surface to properly arrange the electrical cable and the signal generator before the autonomous mobile device can operate. Such procedure can be time-consuming to perform. Moreover, the signal generator must continuously provide an electrical current to the electrical cable when the autonomous mobile device is in operation. As a result, power consumption of the conventional autonomous mobile device system is somewhat high.

### SUMMARY OF THE INVENTION

Therefore, one object of the present invention is to provide an autonomous mobile device system that can achieve the same effect as that of the conventional autonomous mobile device system while having a relatively higher power efficiency.

Accordingly, an autonomous mobile device system of the present invention comprises a plurality of magnetic components and an autonomous mobile device.

The magnetic components are adapted to be arranged on a surface in a spaced-apart manner and produce a magnetic field serving as a virtual boundary on the surface.

The autonomous mobile device is configured to move on the surface, and includes a housing, first and second magnetic sensors, and a motion control module.

The first and second magnetic sensors are disposed at the housing for detecting magnetic field produced by the magnetic components. The motion control module is disposed at the housing for controlling movement of the autonomous mobile device, and is operable in a first movement mode. In the first movement mode, the motion control module restrains the autonomous mobile device from crossing the virtual boundary when one of the first and second magnetic sensors detects the magnetic field produced by the magnetic components.

Preferably, the motion control module is further operable in a second movement mode after the autonomous mobile device completes a predetermined task. In the second movement mode, the motion control module allows the autonomous mobile device to cross the virtual boundary.

Another object of the present invention is to provide an autonomous mobile device that is incorporated in the aforesaid autonomous mobile device system.

Accordingly, an autonomous mobile device of the present invention is configured to move on a surface. A virtual boundary is provided by arranging, on the surface, a plurality of magnetic components in a spaced-apart manner, and the magnetic components produce a magnetic field serving as the virtual boundary. The autonomous mobile device comprises a housing, first and second magnetic sensors, and a motion control module.

The first and second magnetic sensors are disposed at the housing for detecting magnetic field produced by the magnetic components. The motion control module is disposed at the housing for controlling movement of the autonomous mobile device, and is operable in a first movement mode. In the first movement mode, the motion control module restrains the autonomous mobile device from crossing the virtual boundary when one of the first and second magnetic sensors detects the magnetic field produced by the magnetic components.

Preferably, the motion control module is further operable in a second movement mode after the autonomous mobile device completes a predetermined task. In the second movement mode, the motion control module allows the autonomous mobile device to cross the virtual boundary.

Yet another object of the present invention is to provide a method for restraining movement range of an autonomous mobile device.

Accordingly, a method of the present invention comprises the following steps of:

a) providing a plurality of magnetic components on a surface, the magnetic components producing a magnetic field serving as a virtual boundary on the surface;

b) providing first and second magnetic sensors on the autonomous mobile device, the first and second magnetic sensors being configured for detecting the magnetic field produced by the magnetic components; and

c) configuring the autonomous mobile device to operate in a first movement mode, in which the autonomous mobile device is restrained from crossing the virtual boundary when one of the first and second magnetic sensors detects the magnetic field produced by the magnetic components.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a preferred embodiment of an autonomous mobile device system according to the invention;

FIG. 2 is a schematic sectional view of the autonomous mobile device system of FIG. 1;

FIG. 3 is a schematic block diagram illustrating the components of an autonomous mobile device according to the invention; and

FIG. 4 is a flow chart of a method of restraining movement range of the autonomous mobile device according to the invention.

### DETAILED DESCRIPTION OF THE PREFERRED EMBODIMENT

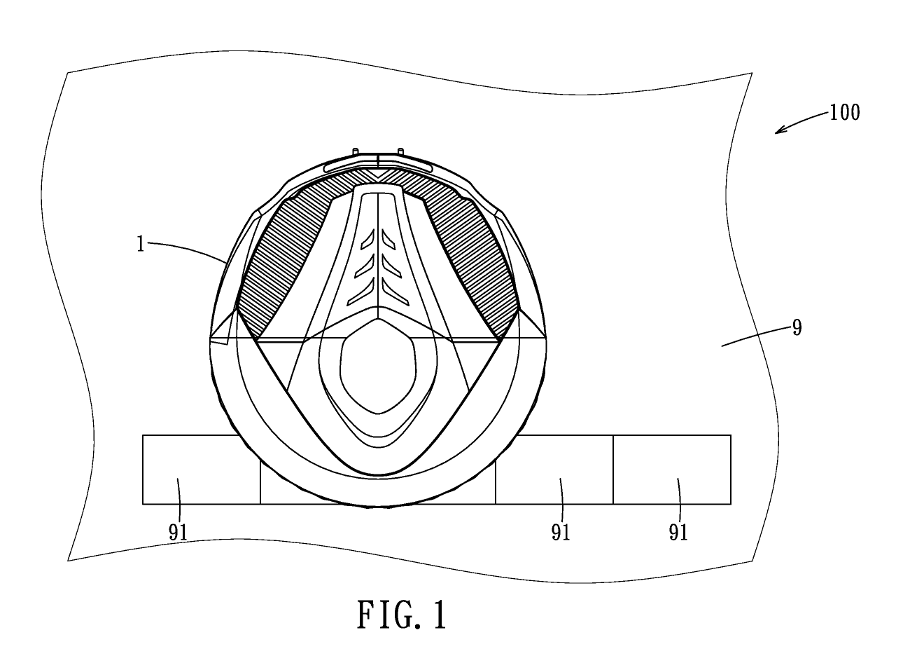

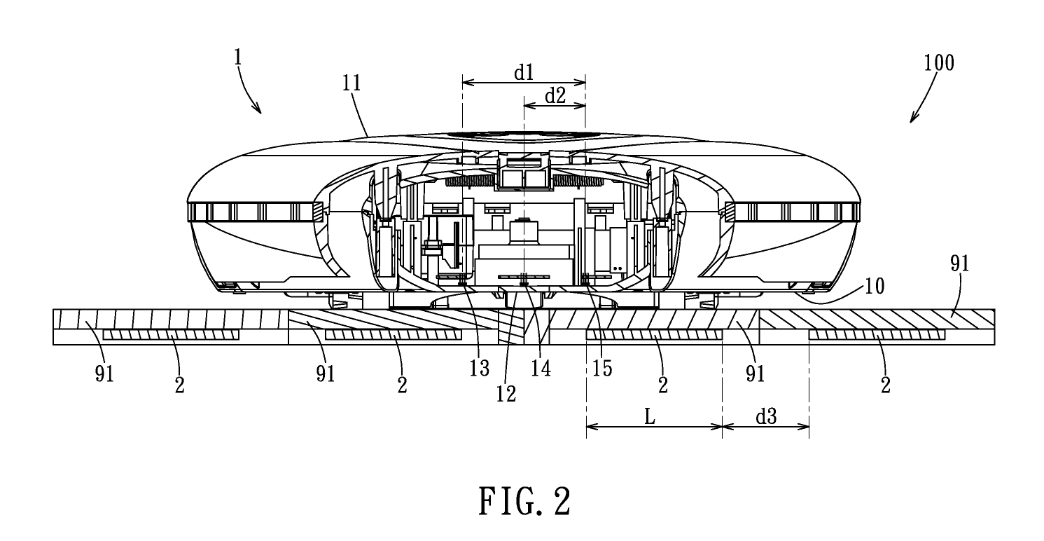

As shown in FIGS. 1 and 2, the preferred embodiment of an autonomous mobile device system 100 according to the present invention comprises an autonomous mobile device 1, which for example is a floor scrubber in this embodiment, and a plurality of magnetic components 2. The autonomous mobile device 1 is configured to operate on a surface 9, on which the magnetic components 2 are placed. In this embodiment, each of the magnetic components 2 has the same length (l), is embedded into a floor piece 91, and is made of magnetic iron.

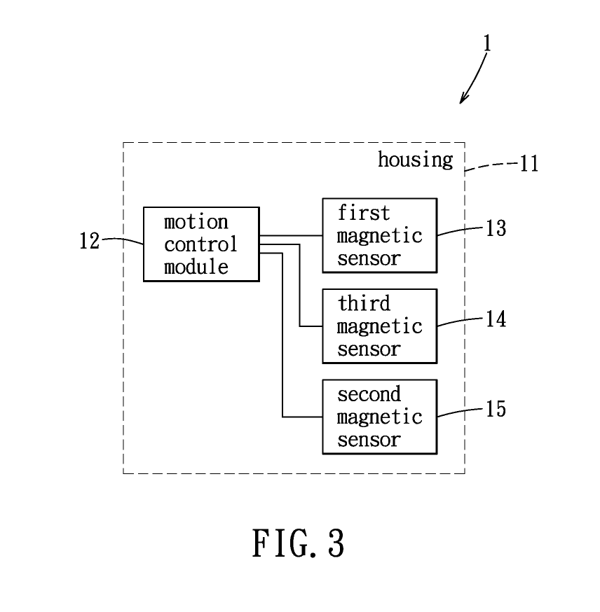

Referring to FIGS. 2 and 3, the autonomous mobile device 1 includes a housing 11, a motion control module 12, first and second magnetic sensors 13 and 15 that are spaced apart by a distance (d₁), and a third magnetic sensor 14 that is disposed between and spaced from the first and second magnetic sensors 13 and 15 by an equal distance (d₂).

The motion control module 12 is disposed in the housing 11 for controlling movement of the autonomous mobile device 1. In this embodiment, the movement of the autonomous mobile device 1 may include linear movement and rotation. The first to third magnetic sensors 13 to 15 are disposed in the housing 11 for detecting magnetic field produced by the magnetic components 2.

Specifically, the housing 11 has a base surface 10, on which the first to third magnetic sensors 13 to 15 are disposed in a manner that adjacent ones of the first, second and third magnetic sensors 13 to 15 are spaced apart from each other by an equal amount (d₂). In addition, the magnetic components 2 are arranged on the surface 9 in a spaced-apart manner and adjacent ones of the magnetic components 2 are spaced apart from each other by an equal distance (d₃), and generate the magnetic field serving as a virtual boundary. In this embodiment, the virtual boundary can cooperate with physical obstacles, such as a wall, to define a closed area for the autonomous mobile device 1 to perform a predetermined task (i.e., cleaning the floor within the area) therein. For example, the magnetic components 2 can be arranged at an entrance of a room, and as a result, the room is considered a closed area defined by the virtual boundary and surrounding walls of the room. In other embodiments, the closed area can be defined solely by arranging the virtual boundary in a closed manner.

The motion control module 12 of the autonomous mobile device 1 is operable in a first movement mode, in which the motion control module 12 restrains the autonomous mobile device 1 from crossing the virtual boundary when one of the first to third magnetic sensors 13 to 15 detects the magnetic field produced by the magnetic components 2. When the predetermined task is completed by the autonomous mobile device 1, i.e., the floor within the area is cleaned, the motion control module 12 of the autonomous mobile device 1 is operable in a second movement mode, in which the motion control module 12 allows the autonomous mobile device 1 to cross the virtual boundary.

Specifically, the main difference between the two movement modes is the decision as to whether the autonomous mobile device 1 should cross the virtual boundary when one of the first to third magnetic sensors 13 to 15 detects the magnetic field produced by the magnetic components 2. For example, when the autonomous mobile device 1 is performing the task (and thus the motion control module 12 operates in the first movement mode), the motion control module 12 does not allow the autonomous mobile device 1 to cross the virtual boundary when the autonomous mobile device 1 moves close to the virtual boundary (i.e., one of the first to third magnetic sensors 13 to 15 detects the magnetic field). Contrarily, when the autonomous mobile device 1 completes the task (and thus the motion control module 12 operates in the second movement mode), the motion control module 12 allows the autonomous mobile device 1 to cross the virtual boundary when the autonomous mobile device 1 moves close to the virtual boundary.

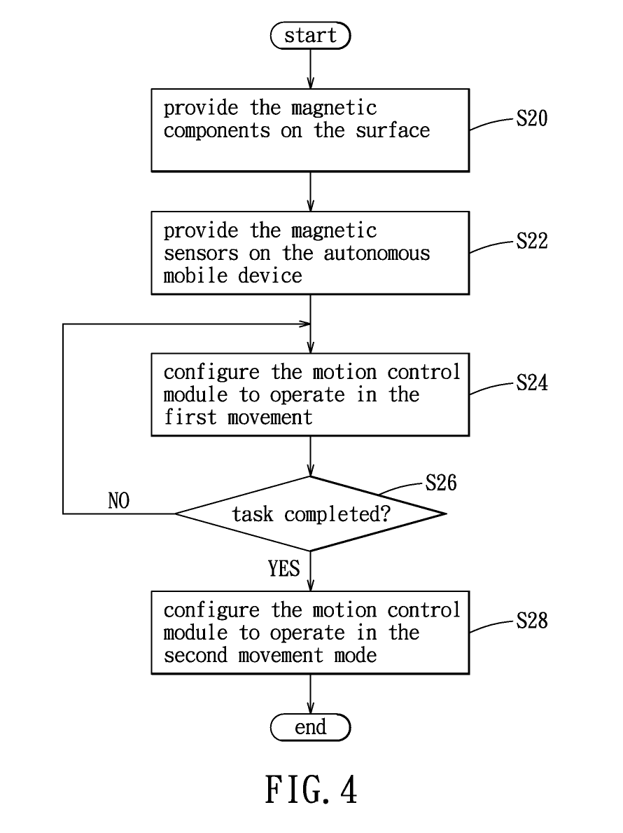

Further referring to FIG. 4, a method of restraining the movement range of the autonomous mobile device 1 moving on the surface 9 is now described.

Firstly, the magnetic components 2 are provided on the surface 9 in step S20 for defining the specific area. Then, the first to third magnetic sensors 13 to 15 are provided on the autonomous mobile device 1 in step S22. After the magnetic components 2 and the first to third magnetic sensors 13 to 15 are arranged, the motion control module 12 of the autonomous mobile device 1 can be configured to operate in the first movement mode in step S24 (i.e., to begin performing the task within the specific area).

During operation, the motion control module 12 of the autonomous mobile device 1 is configured to determine whether the task is completed in step S26. When the determination is affirmative, the flow proceeds to step S28, in which the motion control module 12 of the autonomous mobile device 1 can be configured to operate in the second movement mode. Otherwise, the flow goes back to step S24.

In this embodiment, adjacent ones of the magnetic components 2 have the same distance (d₃) therebetween, and the magnetic components 2 have the same length (l) along the virtual boundary. In order to avoid the case in which the autonomous mobile device 1 undesirably crosses the virtual boundary due to the magnetic field being undetected by the magnetic components 2, some conditions for arranging the magnetic components 2 and the first to third magnetic sensors 13 to 15 can be imposed. For example: (1) the first to third magnetic sensors 13 to 15 should be arranged such that the length (l) is greater than the distance (d₂); and (2) the magnetic components 2 should be arranged in a manner that the distance (d₁) is greater than the distance (d₂). As a result, it is ensured that the autonomous mobile device 1 may detect the magnetic field produced by the magnetic components 2 when moved close to the virtual boundary.

Note that the autonomous mobile device system 100 is able to operate in the case where the magnetic components 2 have unequal lengths, and/or where the first to third magnetic sensors 13 to 15 do not have the same distance therebetween. In such case, the following conditions can be applied: (1) a distance between the first and second magnetic sensors 13 and 15 is greater than a largest distance between adjacent ones of the magnetic components 2; and (2) the length of a shortest one of the magnetic components 2 along the virtual boundary is greater than a distance between adjacent ones of the first and second magnetic sensors 13 to 15. In other embodiments, additional magnetic sensors may be disposed on the base surface 10 of the housing 11 in order to reduce the distance between adjacent magnetic sensors. In such embodiments, a longest distance between adjacent ones of the magnetic components 2 should be smaller than a distance between extremely disposed ones of the magnetic sensors.

To sum up, the present invention uses the magnetic components 2 for defining the specific area in which the autonomous mobile device 1 performs the task, such that no electrical wiring procedure is required to be performed. Instead, simply arranging the magnetic components 2 or the floor pieces 91 containing the magnetic components 2 can also achieve the similar effect of providing the virtual boundary. Moreover, the magnetic components 2 do not need electricity to produce magnetic field, resulting in higher power efficiency over the conventional autonomous mobile device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An autonomous mobile device system comprising:
a plurality of magnetic components that are adapted to be arranged on a surface in a spaced-apart manner and that produce a magnetic field serving as a virtual boundary on the surface; and
an autonomous mobile device that is configured to move on the surface, and that includes
a housing,
first and second magnetic sensors disposed at said housing for detecting the magnetic field produced by said magnetic components, and
a motion control module disposed at said housing for controlling movement of said autonomous mobile device, and being operable in a first movement mode, in which said motion control module restrains said autonomous mobile device from crossing the virtual boundary when one of said first and second magnetic sensors detects the magnetic field produced by said magnetic components.

2. The autonomous mobile device system of claim 1, wherein a distance between said first and second magnetic sensors is greater than a largest distance between adjacent ones of said magnetic components.

3. The autonomous mobile device system of claim 1, wherein a length of a shortest one of said magnetic components along the virtual boundary is greater than a distance between said first and second magnetic sensors.

4. The autonomous mobile device system of claim 1, wherein said autonomous mobile device further includes a third magnetic sensor spaced apart from and disposed between said first and second magnetic sensors, wherein a length of a shortest one of said magnetic components along the virtual boundary is greater than a distance between an adjacent pair of said first, second and third magnetic sensors.

5. The autonomous mobile device system of claim 1, wherein:
said autonomous mobile device further includes a third magnetic sensor spaced from and disposed between said first and second magnetic sensors in a manner that said third magnetic sensor is equally spaced apart from said first and second magnetic sensors;
said magnetic components have a uniform length along the virtual boundary and greater than a distance between adjacent ones of said first, second and third magnetic sensors; and
a distance between adjacent ones of said magnetic components is smaller than a distance between said first and second magnetic sensors.

6. The autonomous mobile device system of claim 1, wherein said magnetic components are made of magnetic iron.

7. The autonomous mobile device system of claim 1, wherein said motion control module is further operable in a second movement mode, in which said motion control module allows said autonomous mobile device to cross the virtual boundary, after said autonomous mobile device completes a predetermined task.

8. An autonomous mobile device configured to move on a surface, on which a virtual boundary is provided by arranging, on the surface, a plurality of magnetic components in a spaced-apart manner, the magnetic components producing a magnetic field serving as the virtual boundary, said autonomous mobile device comprising:
a housing,
first and second magnetic sensors disposed at said housing for detecting the magnetic field produced by the magnetic components, and
a motion control module disposed at said housing for controlling movement of said autonomous mobile device, and being operable in a first movement mode, in which said motion control module restrains said autonomous mobile device from crossing the virtual boundary when one of said first and second magnetic sensors detects the magnetic field produced by the magnetic components.

9. The autonomous mobile device of claim 8, further comprising a third magnetic sensor spaced apart from and disposed between said first and second magnetic sensors.

10. The autonomous mobile device of claim 9, wherein said third magnetic sensor is equally spaced apart from said first and second magnetic sensors.

11. The autonomous mobile device of claim 8, wherein said motion control module is further operable in a second movement mode, in which said motion control module allows said autonomous mobile device to cross the virtual boundary, after said autonomous mobile device completes a predetermined task.

12. A method of restraining movement range of an autonomous mobile device moving on a surface and including a motion control module for controlling movement of the autonomous mobile device, said method comprising the following steps of:
a) providing a plurality of magnetic components on the surface, the magnetic components producing a magnetic field serving as a virtual boundary on the surface;
b) providing first and second magnetic sensors on the autonomous mobile device, the first and second magnetic sensors being configured for detecting the magnetic field produced by the magnetic components; and
c) configuring the motion control module of the autonomous mobile device to operate in a first movement mode, in which the autonomous mobile device is restrained from crossing the virtual boundary when one of the first and second magnetic sensors detects the magnetic field produced by the magnetic components.

13. The method of claim 12, wherein, in steps a) and b), a distance between the first and second magnetic sensors is greater than a largest distance between adjacent ones of the magnetic components.

14. The method of claim 12, wherein, in steps a) and b), a length of a shortest one of the magnetic components along the virtual boundary is greater than a distance between the first and second magnetic sensors.

15. The method of claim 12, wherein, in steps a) and b), a third magnetic sensor is further provided on the autonomous mobile device and is spaced apart from and disposed between the first and second magnetic sensors, and a length of a shortest one of the magnetic components along the virtual boundary is greater than a distance between an adjacent pair of the first, second and third magnetic sensors.

16. The method of claim 12, wherein, in steps a) and b):
a third magnetic sensor is further provided on the autonomous mobile device, and is spaced apart from and disposed between the first and second magnetic sensors in a manner that the third magnetic sensor is equally spaced apart from the first and second magnetic sensors;
the magnetic components have a uniform length along the virtual boundary and greater than a distance between adjacent ones of the first, second and third magnetic sensors; and
a distance between adjacent ones of the magnetic components is smaller than a distance between the first and second magnetic sensors.

17. The method of claim 12, wherein, in step a), the magnetic components are made of magnetic iron.

18. The method of claim 12, further comprising, after step c), a step of configuring the motion control module of the autonomous mobile device to operate in a second movement mode, in which the motion control module allows the autonomous mobile device to cross the virtual boundary, after the autonomous mobile device completes a predetermined task.
